(19) United States
(12) Patent Application Publication
(10) Pub. No.: US 2026/0093530 A1
(43) Pub. Date: Apr. 2, 2026

(54) Data Center Operating System

(71) Applicant: Verrus, LLC, Beverly Hills, CA (US)

(72) Inventors: Christopher Alan Coco, San Francisco, CA (US); Anand Ramesh, Los Altos, CA (US); Jimmy Clidaras, Boca Raton, FL (US); Matthieu Frederic Jean-Jacques Monsch, Seattle, WA (US); Saurav Talukdar, San Jose, CA (US); Jeremy Alan Rice, Santa Monica, CA (US); Nelson Louis Abramson, Beverly Hills, CA (US); Benjamin Ray Wheeler, San Francisco, CA (US); Nithya Manickam, Redwood City, CA (US); Carlos Rios, San Mateo, CA (US)

(21) Appl. No.: 18/903,497

(22) Filed: Oct. 1, 2024

(51) Int. Cl. G06F 9/48; G06F 9/50

(52) U.S. Cl. CPC G06F 9/4893; G06F 9/5044

(57) ABSTRACT

A computer-implemented method for managing physical sub-systems in a computer data center is disclosed. The method includes registering, with the operating system, a plurality of physical resources that serve the computer data center with electrical or cooling services; scheduling, with the operating system, tasks that include electrical tasks, cooling tasks, or both, to be performed in response to compute loads to be encountered by the computer data center; and executing, with the operating system, the scheduled tasks with one or more registered physical resources by selecting a mix of electrical power sources sufficient to execute the scheduled tasks and to optimize power use parameters defined for the computer data center.

### TECHNICAL FIELD

This document generally describes technology related to an operating system that manages physical components associated with a computer data center.

### BACKGROUND

Computer data centers continue to grow in their size and in their importance to the economy. Many now cost over $1 billion to construct and bring to operation (and often much more), with hundreds or thousands of computer racks inside, and hundreds of thousands processors (e.g., for processing search queries or other requests in real-time, or training AI models over a longer period with a more flexible schedule).

High levels of computer processing generally require relatively high levels of electrical power input to operate the computers in a data center. The conversion of that electricity to computing work then creates heat, and that heat needs to be dispersed. Cooling systems (with, e.g., fans, pumps, and compressors) can then require additional electrical power to perform such dissipation of heat. Additional auxiliary systems may further require electrical power, such as for lighting, control systems, and equipment for servicing and repairing the computing and other equipment.

### SUMMARY

This document generally describes computer-based technology for an operating system that technologically manages computing and auxiliary services for a computer data center both effectively and efficiently. In particular, the systems and methods described here may permit goals to be set for operating a data center, including performance goals (e.g., operating the compute side of a data center at or above a particular percentage load level), cost goals (e.g., performing a certain amount of compute for the lowest cost in terms of electricity and other inputs such as fuel for back-up generators), and other relevant goals. The described systems may perform operations typically associated with an operating system, such as managing communication with hardware (e.g., chillers, fans, other computer systems, and the like), ordering of booting and re-booting system-wide control for a data center, operating in a “safe” mode, managing power flow in the data center by selecting what physical devices will perform compute and cooling functions and selecting what physical devices will deliver electrical power for such operations, and similar “core” computing functions for the data center.

More particularly, a data center management system as described here can model the computing and auxiliary components of a data center according to a operating system model. For example, sources of electrical power or cooling capability can be modeled like operating system resources such as RAM memory, flash memory, hard drive storage, and tape storage—where certain sources may provide more immediately service but may cost more. In the data center then, on-site battery banks may be comparable to RAM, grid power may be comparable to flash memory or hard drive storage, and back-up generators may be comparable to tape storage (because of lag in starting them). Similarly, physical components in the data center, such as battery banks, generators, chillers, and cold-water storage, may be treated like physical components for a traditional operating system, such as hard drives or peripheral devices such as printers. Such physical components may be assigned physical parameters, such as capacity, and may be assigned performance parameters such as BTUH. The physical parameters may be provided to a computerized management system upon installing each physical component (like plug-and-play in a traditional operating system), and may have its performance parameters both provided initially but also learned over time as the data center operates. For example, the actual output of a battery bank may be correlated to a certain amount of compute load over time (e.g., x units of processing depletes y units of battery storage) as the system operates (and where data about incoming compute load and changes in the status of the battery bank can be observed).

In one implementation, a computer-implemented method for managing physical sub-systems in a computer data center using a data center-based operating system is disclosed. The method comprises registering, with the operating system, a plurality of physical resources that serve the computer data center with electrical or cooling services; scheduling, with the operating system, tasks that include electrical tasks, cooling tasks, or both, to be performed in response to compute loads to be encountered by the computer data center; and executing, with the operating system, the scheduled tasks with one or more registered physical resources by selecting a mix of electrical power sources sufficient to execute the scheduled tasks and to optimize power use parameters defined for the computer data center. The plurality of physical resources comprise a source of electrical power connectable so as to power cooling components and computer server equipment, and scheduling the tasks comprises determining a future amount of needed cooling or electric power based on a received indicator of computing to be performed by the computer data center, data indicating a change in a parameter that affects cooling or electric power for the data center, or both.

In some instances, the plurality of physical resources comprises distributed energy resources (DERs), and scheduling the tasks comprises virtually partitioning DER capacity for different uses in the computer data center. The method can further comprise updating a learning model of registered physical resources using data about recent performance by the registered physical resources, wherein the updating stores data indicative of how particular registered physical resources perform and parameters in which the registered physical resources performed. The method can additionally comprise monitoring background processes of the computer operating system to monitor and test operability of registered physical resources in the system. Also, the method may comprise automatically deactivating a registered physical resource upon determining that preventative maintenance is due for the registered physical resource, determining with the operating system a timing of the scheduled tasks and selection of registered physical resources that will optimize a defined goal for the data center system, and causing the optimizing timing and selection of registered resources to be executed, and imposing secure communications between the operating system that the plurality of physical resources by requiring authentication and authorization before communicating data to particular ones of the plurality of physical resources.

The recited method can additionally comprise identifying that a major fault has occurred in control of the plurality of physical resources; in response to the identifying, causing the computer data center to operate at a reduced level safe mode while the operating system corrects the major fault; resetting operating system; and re-imposing control over the ones of the plurality of physical resources by the operating system. In addition, the method can comprise periodically recalculating deployable IT capacity and using the periodic recalculation to schedule the tasks.

In another implementation, a computer operating system for automated management of a computer data center is disclosed. The operating system comprises one or more resource drivers that allow the system to interact with physical resources that become registered with the system and that provide electrical or cooling services to the computer data center; a task scheduler arranged to schedule tasks that include electrical tasks, cooling tasks, or both, to be performed in response to compute loads determined to be encountered by the computer data center; and a device interface arranged to cause execution of the scheduled tasks with one or more registered physical resources by selecting a mix of electrical power sources sufficient to execute the scheduled tasks and to optimize power use parameters defined for the computer data center. The plurality of physical resources can comprise a source of electrical power connectable so as to power cooling components and computer server equipment, and scheduling the tasks can comprise determining a future amount of needed cooling or electric power based on a received indicator of computing to be performed by the computer data center, data indicating a change in a parameter that affects cooling or electric power for the data center, or both.

In some aspects, the plurality of physical resources comprises distributed energy resources (DERs), and scheduling the tasks comprises virtually partitioning DER capacity for different uses in the computer data center. In other aspects, the operating system is programmed to update a learning model of registered physical resources using data about recent performance by the registered physical resources, wherein the updating stores data indicative of how particular registered physical resources perform and parameters in which the registered physical resources performed. Further yet, the operating system can be programmed to monitor background processes of the computer operating system to monitor and test operability of registered physical resources in the system.

In other implementations, the system is programmed to automatically deactivate a registered physical resource upon determining that preventative maintenance is due for the registered physical resource. Also, the operating system can be programmed to: (a) determine a timing of the scheduled tasks and selection of registered physical resources that will optimize a defined goal for the data center system, and (b) cause the optimizing timing and selection of registered resources to be executed. In addition, the operating system can be programmed to perform the actions of: (a) identifying that a major fault has occurred in control of the plurality of physical resources; (b) in response to the identifying, causing the computer data center to operate at a reduced level safe mode while the operating system corrects the major fault; (c) resetting operating system; and (d) re-imposing control over the ones of the plurality of physical resources by the operating system.

The details of one or more embodiments are set forth in the accompanying drawings and the description below. Other features and advantages will be apparent from the description and drawings, and from the claims.

### DESCRIPTION OF DRAWINGS

FIG. 1 is a block diagram of a example operating system for a computer data center.

FIG. 2 is a block diagram of physical components and their interaction in a computer data center.

FIG. 3A is a flow chart showing enrollment of, and operation of, a physical component in a computer data center.

FIG. 3B is a flow chart showing management of cooling infrastructure in a computer data center.

FIG. 3C is a flow chart of a process for rebooting a data center when a fault occurs.

FIG. 4 shows an example computer system that can be used singularly or in multiples to carry out the techniques described herein.

Like reference symbols in the various drawings indicate like elements.

### DETAILED DESCRIPTION

This document generally describes computer-based systems and techniques for managing a computer data center, both of the main computing machinery that carries out the “compute” task, and also auxiliary systems that support that main compute, such as electrical supply, cooling, lighting, and control systems.

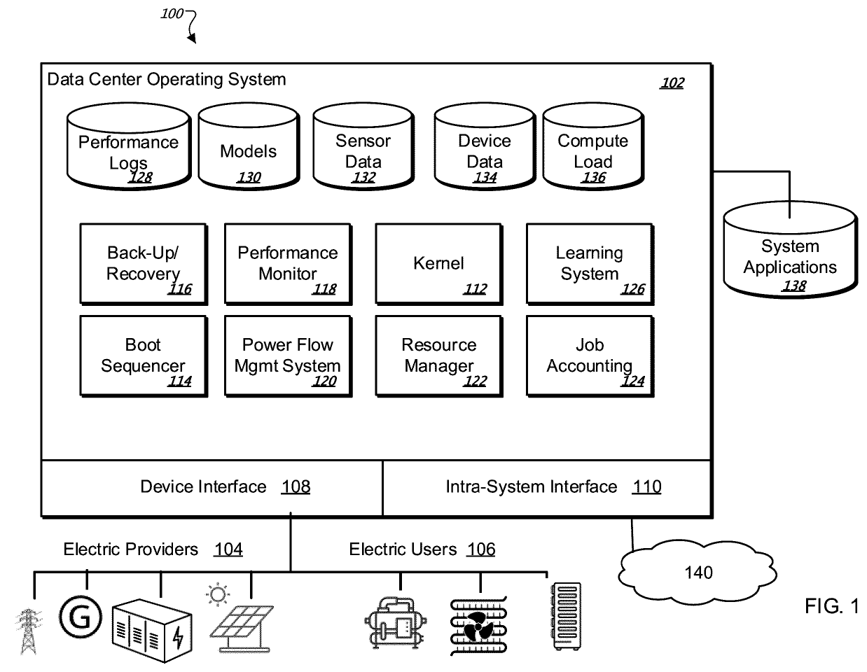

FIG. 1 is a block diagram of an example operating system (OS) 102 for a computer data center 100. In general, the OS 102 performs basic functions related to control of hardware components for a data center—e.g., battery banks, chillers, gen-sets, fans, pumps, computer and networking equipment, lighting, and the like. Those functions can include discovery of and registration of each such component via a local area network and/or manual registration (e.g., with actions led by an operator and potentially in combination with an install script), followed by sending instructions so as to control the components in a coordinated and efficient manner. For example, the OS 102 can control the components so as to achieve one or more goals for the data center, such as processing a certain percentage of compute demand within a defined time period, while minimizing electrical energy use. The OS 102 can also monitor the health of components within the data center, switch load to other components when certain components cannot or should not handle the load (e.g., if a chiller suddenly goes off-line, or if it is taken off-line for scheduled maintenance), and enter a “safe mode” and general handling and reporting when there are greater problems, and then come elegantly out of the safe mode and back to normal, continuous operation. Other operations of the OS 102 are further described with respect to this and the other figures below.

Referring more specifically to FIG. 1, the OS 102 operates within a particular environment and uses a number of exemplary components to perform its operations on physical devices that also operate in that environment—e.g., one or more data center buildings on one or more data center campuses. In this example, that environment is a data center 100 in which the OS 102 controls a number of physical devices like chillers, battery banks, grid connections, fans and pumps, and gen-sets. The features of OS 102 may also be applicable in environments other than data centers, where computer control of physical components like HVAC and related building control systems is needed, and may operate in a closed-loop manner like the systems and methods described above and below.

With respect to the environment around OS 102, the OS 102 is shown as controlling both electric (or electricity) providers 104 and electric (or electricity) users 106 for the data center 100. A main purpose of the OS 102 is to ensure that operations needed to process data effectively (e.g., accurately and timely) and efficiently (e.g., for lowest practical cost) are carried out, and that adequate cooling is provided to compensate for such operations, and adequate electricity is made available for both the processing and the cooling, along with other energy-using parts of a data center (e.g., human-occupied spaces and the like).

The electric providers 104 may be originators of electric power, such as a grid (represented here by high-lines), one or more gensets (represented by the G-in-a-circle symbol) or on-site or nearby renewable energy (represented here by a solar installation, though it could include local wind, hydro, and/or geo-thermal power sources). The electric providers 104 may also be storers of electricity generated elsewhere, such as indicated here by a battery electric storage system (BESS), which may include a large number of battery cells, along with control, cooling, ventilation, and other resources needed to deliver electric energy at required rates from the BESS.

The electric users 106 may include the various devices at a data center 100 that deliver (directly or indirectly) computing. In this example, the users 106 include equipment for producing cooled or chilled water, such as chillers (pictured), cooling towers, pumps, control valves, and the like. They may also include fan-coil units (pictured) and other components for transferring heat to the cooling water from air or warmed water in a data center. And the users 106 are shown here to include the racks of computer equipment (e.g., servers and networking equipment) itself—where the “compute” equipment may be dispatched in a separate-but-related decision loop as compared to the cooling and other equipment (where the former is first dispatched to meet compute-related requirements, and the latter is dispatched based on computations about how much heat the compute will generate).

An intra-system interface 110 may be part of the device interface 108 or be separate, and may permit communications by components running in the OS 102 with outside resources. As a main example, the system here may be organized to have multiple hierarchical levels, and OS 102 may operate in each of those levels, though in a different manner for each. For example, at a data center building level, the OS 102 may communicate with certain compute devices and cooling devices, like those inside the particular building. Such a system may receive instructions from instantiations of OS 102 that are higher in the hierarchy, e.g., to coordinate operations across multiple buildings. At a data center campus level, another computer may run OS 102 to accomplish such coordination. Such an OS 102 may determine how much cooling is needed in each building at a site and may send instructions to instantiations of OS 102 at those buildings to make sure that components like fan-coil units operate at a sufficient level to provide the cooling (and may also poll down to the building-level OSs to determine how much capacity is available). And an instance of OS 102 operating at a global level may receive information from a number of geographically-dispersed facilities that are miles apart to potentially thousands of miles apart, may analyze the data, and may dispatch mechanical and electrical resources across the many data centers in a manner to optimize certain desired criteria, like cost, carbon footprint, life of equipment components, neighborhood issues such as noise during certain times, and other mixtures of criteria.

Other components with which the intra-system interface 110 (or another, related interface) may communicate include various components for providing necessary data to the OS 102. For example, various sensors for the system, such as temperature and humidity sensors for an area in or around the data center 100 may provide data with which OS 102 may compute the amount of electric power that will be needed to provide cooling for a certain level of compute. Other data may be acquired from various sources through a network 140 like the internet, such as pricing data for different utilities from which the data center 102 obtains power, current fuel costs for re-fueling gen-sets (for computing the cost of generated electricity), real-time communications with utilities such as to negotiate “spot” energy costs for short time periods, and weather forecast data to help determine how much capacity may need to be held open in the coming days, whether to charge or discharge a BESS, and other similar future-looking determinations.

The OS 102 may also communicate with storage for systems applications 138, which may contain executable code for applications that users may select and execute in furthering the operation of OS 102. For example, some applications may provide particular user interfaces (UIs) that are particularly suited for subsets of users who operate the OS. Other applications may provide additional information about, and ability to have fine-tuned control over, particular brands of devices like chillers and gen-sets, control of a BESS so that a data center operator may provide grid services to third parties, apps that provide improved and/or specialized data center visualization techniques, and apps to enable customer control of load shedding in response to data center events. In some implementations, an app store may be provided by a company that sells the OS 102 and that allows third parties to submit software applications they have authored and make them available to users of OS 102.

Indicated within the OS 102 are operational components 116-124 that perform functions of the OS 102, and storage components 128-136 that store, organize, update, and make available information on which the operational components can work. Starting with the operational components, a kernel 112 performs basic core OS functions, including organizing boot-up of the OS 102, and organizing various storage and device drivers (e.g., for monitoring and control of electric providers 104 and electric users 106). Where the OS 102 operates on top of a computer OS, the kernel 112 may take on a more non-traditional form and may supplement the kernel-like functions otherwise performed by the main computer OS's kernel.

Associated with the kernel 112, a boot sequencer 114 is responsible for causing components of the data center 100 to activate in coordination with each other, such as when the system is first started up or when the system attempts to return to normal operation after it has entered a safe mode and general handling and reporting (or has performed a full boot sequence). In particular, the boot sequencer may include instructions that cause it to send control signals to electric providers 104 and electric users 106 in a sequential manner, such as by first operating electrical switches to make electric power available at an adequate level, then starting pumps and chillers in sequence (when the system is set to operate multiple such sub-systems) so that their load on the system is gradually applied, and then providing control signals to start and control other components that are needed later and whose operation may depend on prior operation of the other components. Such boot sequencer 114 may thus be programmed so as to bring the system “up” smoothly and logically and to get it to full-scale operation.

Back-up/recovery engine 116 may operate in tandem with the boot sequencer 114 to move the system from a full-operation state to a “safe” state and from an off or safe state to a full-operation state. Back-up/recovery engine 116 may operate to safely shut down operation of the data center 100 when unsafe conditions are identified, such as if no necessary source of electrical power is available and only minimal battery supply can be identified. In such a situation, back-up/recovery engine 116 may send commands to stop operations in a logical sequence, to capture data about system operation as part of that process, and then to coordinate with the boot sequencer 114 to bring the system back up to full operation. In some situations, back-up/recovery engine 116 may simply shift fully or partially into a “safe” mode—such as by terminating its control of certain devices and allowing them to turn to their own autonomous control. For example, a BESS system may use its own controls to provide power to the system, a chiller may simply monitor the outgoing temperature of chilled water or some other parameter to control its own operation and respond to system changes, and other components may operate similarly. While this occurs, the back-up/recovery engine 116 and boot sequencer 114 may be performing operations to transition each of the devices, in a logical programmed sequence, from autonomous control to systemic control by the OS 102.

Performance monitor 118 is responsible for gathering information about the actual performance of the system. For example, the OS 102 might send a chiller control signals to lower its outgoing control temperature for chilled water by two degrees, in anticipation of a soon-to-start large compute load on the data center 102 so as to “pre-cool” the chilled water a bit and get ahead of the coming higher load. The performance monitor 118 may subsequently receive reports from the chiller and/or a temperature sensor in a pipe coming from the chiller to receive information on the actual temperature the chiller achieves, the time required to push the temperature down two degrees, and the time and level to which that temperature rebounds when the cooling system starts to “feel” the increased heating load caused by the large incoming compute job. As a corollary, a large compute load may result in the OS 102 running the system warmer than nominal for a time so as to stay within a defined power envelope for the system, which can avoid an overload, allow for operating equipment at levels that maximize their lifespans, and allow the system if it is using a BESS or gensets that may run out of power, to get to a time when grid power prices step down. Performance monitor 118 may track all such activities over and save data that may be used by other systems to model the operation and reaction of the data center system to changes.

Power flow management system (PFMS) 120 is the structure through which the system causes power to be made available by the electric providers 104, and used by the electric users 106. For example, PFMS 120 can make determinations about how much electrical power will be needed by a system for approaching compute needs, how much cooling will be needed and when, and then how much electrical power will be needed to execute the cooling (e.g., to operate chillers, pumps, and fans, in addition to powered valves). PFMS 120 may then determine amounts of power needed at particular points over time, and where the power needs to be provided within the system. PFMS 120 may then execute a plan to make such power available. For example, if PFMS determines that a certain amount of power can be provided by a BESS or local renewable resource in a short time period before the price of grid power falls, it may send instructions to cause electrical switches to be arranged so that the BESS is connected to a power bus that makes power available to relevant components. PFMS 120 may also cause any relevant electric users 106 to receive control signals so that they operate to use the determined amount of power. PFMS 120 can also monitor such operation over time, either via itself or using performance monitor 118, to ensure, e.g., that chillers it determined would use X watts of power are actually using that much power, or it may cause updated control signals to be sent to the chillers so as to lower their electric use if such is necessary for continued operation of the system (e.g., if the current operating state will cause the BESS to be depleted before lower-priced grid power is available, and the system can safely handle slightly higher-temperature cooling water for that time period).

Resource manager 122 is responsible for monitoring the presence and status of the various components such as electric providers 104 and electric users 106. For example, boot sequencer 114 may be programmed to poll all devices to check their operational status before selecting them for operation when the system is first booting. If a particular device does not respond, if it responds that it is soon scheduled to receive maintenance, or if it responds with an indication that it is not fully operational, the boot sequencer 114 can avoid booting such a device, and can report the device status to the resource manager 122. The resource manager 122 may then log all such information (along with information it can obtain by performing its own polling of the device, or receiving reports from the devices that are pushed to the resource manager 122, e.g., periodically).

The resource manager 122 may also be programmed to perform certain operations using the information it receives from the devices. For example, it can generate repair or maintenance alerts for personnel at a data center, so that they are instructed to physically inspect and perhaps repair a device that is not responding, that has reported that maintenance is soon due, or that responds that it is operational only sub-optimally. The resource manager 122 may also respond to queries from other system components to provide information about the devices, e.g., to provide historical load levels so as to assist a central planning component in determining whether additional devices (e.g., a new chiller in a row of chillers connected in parallel) need to be added to the system to meet current and expected demand. For example, the system may observe both that there is a spike in traffic each year in late November, that traffic has grown annually at 10%, that the resource manager 122 indicates that the bank of chillers has been operating in September close to its limit—and thus that an additional chiller should be added before the expected peak in traffic and needed cooling in late November that might otherwise exceed the system's cooling capacity.

Job accounting engine 124 may assist the resource manager 122 in tracking what devices are operating, how much electric power they are using, how much electric power is provided by other devices, and the like. As job accounting in a traditional OS monitors compute jobs that are using certain amounts of the CPU time, and database and communication functions, the job accounting engine 124 may analogously track what sorts of activities are providing or using certain amounts of power, are creating spikes in power needs, and other such relevant considerations. The data produced by job accounting engine 124 and resource manager 122 may be used by the various other components, such as PFMS 120, to affect what devices are select to provide and use power, and to determine whether and how certain predicted loads for compute and electric power can be handled by the system.

As another operating system component, learning system 126 may take a number of forms for expert systems and machine learning. In particular, learning system 126 may observe actual operation of devices in the system (e.g., with data gathered and organized by performance monitor 118), and provide information or even direct control of the system in the future with such information. For example, learning system 126 may determine that a certain set of fans does not provide cooling as quickly as the system has them modeled, e.g., based on thermostat readings inside the data center 100 associated with the fans. The learning system 126 may identify from such observation, an actual response rate of the system to the fans, and from that, it may determine that the fans should be turned on earlier than they otherwise would, should be supplemented with additional fans, or should be operated at a higher speed. Such updated operation may then be observed by the system, and it may make additional learned changes in the fan operation so as bring the system closer to optimal operation. Further, learning system 126 may generate reports from its observations, where the reports may provide recommended changes that human operators may review and implement where appropriate.

As a final example component, security manager 127 may operate to ensure that unauthorized access or control of system components is blocked by the OS. When access to system resources or control over system resources is sought by a user or by a sub-system, security manager 127 may first be consulted to determine whether the user or sub-system seeking such action is authorized, is authorized to take whatever actions that they are taking, and is who/what it says it is. Access and control authorizations may be defined by a security policy and may vary based on who a particular user is or the role assigned to them in a system, e.g., a senior admin or engineer may have the ability to access and change settings, whereas a junior technician may be able to access only information about the sub-system to which they are assigned, and be able to change no settings or few settings. Similarly, off-site requests for information or control, whether from a user or a separate sub-system, may also be limited—e.g., so that users or instantiations of the OS at data center A can see no detail or very limited detail about operations at data center B. Security manager 127 may also provide auditing, logging, and tracing for requests or other relevant operations by users or made automatically by sub-systems in the system. In this manner, the security manager 127 can both impose security restrictions and also permit reviews to occur when possible security problems occur.

Turning now to the storage examples in FIG. 1, performance logs 128 store detailed data concerning historical operation of the data center 100, such as temperature readings for outdoor air, indoor air in various parts of the data center 100, cooling water temperatures, and compute loads over time (all sampled every few seconds or minutes). The performance logs 128 may thus include extensive data that can be used by, e.g., learning system 126, performance monitor 118, and PFMS 120.

Models 130 may store data that numerically models how the electric, cooling, and other sub-systems operate in a data center 100. For example, models 130 may include data that characterizes the operation of each of electric providers 104 and electric users 106. As one example, models 130 may indicate the level of energy delivered by a BESS both as its charge depletes and over long periods of time (e.g., months or years). Such data may be used by other components, such as the PFMS 120, to identify how much power the BESS can be expected to deliver in a certain situation such that the PFMS 120 can decide to connect the BESS or to instead use a different source of power (e.g., gensets) for an expected power need.

Sensor data 132 may store data like that of the performance logs 128, and may be combined into the performance logs 128. For example, sensor data 132 may include outdoor temperature data measured over the life of the system by sensors outside a data center facility in addition to one or more indoor temperature sensors (e.g., a sensor in each hot aisle and each cool aisle in the facility). Various other sensor data from the facility, from related facilities, and from out-of-system sources obtained through the internet may also be stored.

Device data 134 stores data about particular devices. As an example, the model for discharging of a BESS that was just discussed may be built in models 130 database by accessing device data 134 that show historical operation of the BESS (e.g., reductions in voltage or amperage as the BESS discharges, or as it ages).

Compute load 136 stores data indicating the compute load that the system has faced over time—both in terms of quantity and quality. For example, a certain amount of computing may have been performer over a time period of X minutes on a certain date, and may have been a mix of Y % GPU usage and Z % CPU usage, or Y % performed on gen 1 GPUs and X % performed on gen 2 GPUs. Such data can be accessed and analyzed by operational components such as PFMS 120 to determine connections between compute load and electric power required to carry out that compute load, in addition to compute load, subsequent cooling load, and electric power required to perform such cooling. Using such data, the system can better predict how much electric power will be needed and in what time period, when an indication of an incoming compute load is received by a data center 100.

In operation then, the system 102 shown here (and as described more fully in examples below) can coordinate operation of multiple components and devices to react to changing conditions in terms of computing workload, outdoor temperature, availability and costs of electricity sources, and other changes so as to optimize operation of the data center 100 toward some goal or goals, such as cost savings, reduction of carbon generation, extending total life of certain devices (e.g., by running the devices, to the extent practical, below 80% of full load), and such. For example, a operating system 102 may initially be booted, and may receive information about the current condition of a data center 100, including the availability of various computing and cooling devices, a current temperature of cooling water in the system, current temperatures outside and inside the data center 100 facility, and charging status of a BESS. The OS 102 may initially start a set number of devices to get the data center 100 operating at a basic level, such as by starting pumps to circulate cooling water and starting one chiller in a bank of chillers—so as to keep the facility cool in light of basic loads and idling computer systems. The operating system 102 may then receive an indication of an incoming compute load, which may be expressed in various ways, including a certain number of operations per second for the data center 100 or different zones in the data center 100, a certain level of BTUH heat generation, and the like.

Or the operating system 102 may receive multiple indications on “compute” and perform a heat/cooling determination on its own. For example, for compute jobs that are not scheduled, such as e-commerce interaction on web pages and search requests from the public, historical models may be consulted and estimates of likely demand over time can be determined automatically. For scheduled compute jobs, such as training an AI model with newly identified information, compiling information, performing certain Monte Carlo analyses, and the like, the system may determine how much flexibility exists in scheduling such compute jobs, and may determine a most optimum scheduling to carry them all out in a timely manner, such as by identifying permissible end-times for each scheduled job and spreading them across a predetermined time period, along with the predictions about unscheduled jobs, so as to keep the data center 102 operating at a relatively steady state, or at a higher level when grid energy is cheap and a lower level when it is expensive (as indicated by stored data that reflects one or more pricing agreements with one or more electric utilities).

With compute determined, the operating system 102 may identify levels of cooling needed to match or essentially match the heat generated from the compute operations. Again, this may involve converting compute functions into BTUH. And the system 102 may identify the ability of different cooling components to generate that BTUH level of cooling according to a schedule that may slightly lead, match, or slightly trail the performance of the computing tasks (e.g., after polling the various devices to determine if they are available and how much of their capacity is available). The system 102 then may select particular devices (e.g., via PFMS 120) to provide the support for the compute function, may determine expected electrical load for each such device over time, and may broadcast signals to activate each such device and adjust its operation over time.

With the system 102 thus operating, the system 102 may then monitor its operation, receive and schedule new incoming compute jobs, and monitor for changes around the system, such as changes in outdoor temperature, reductions in efficiency of certain devices, failures or other shut-downs of devices (e.g., for maintenance), and installation or removable of certain electrical or mechanical machines. In response to any such changes, the system 102 can determine what changes in needed electrical power and related services (such as cooling) will be needed, and can update the operation of all the various devices accordingly, such as by changing a temperature set-point for a chiller (if the cooling is not otherwise keeping up), switching from taking power form a BESS to taking it from a genset when the BESS falls below a certain charge level, switching power sources when utility rates change, etc. The operating system 102 in such situations may use the PFMS 120 and related components in such situations to send instructions to cause different devices to operate or the same devices to operate differently over time.

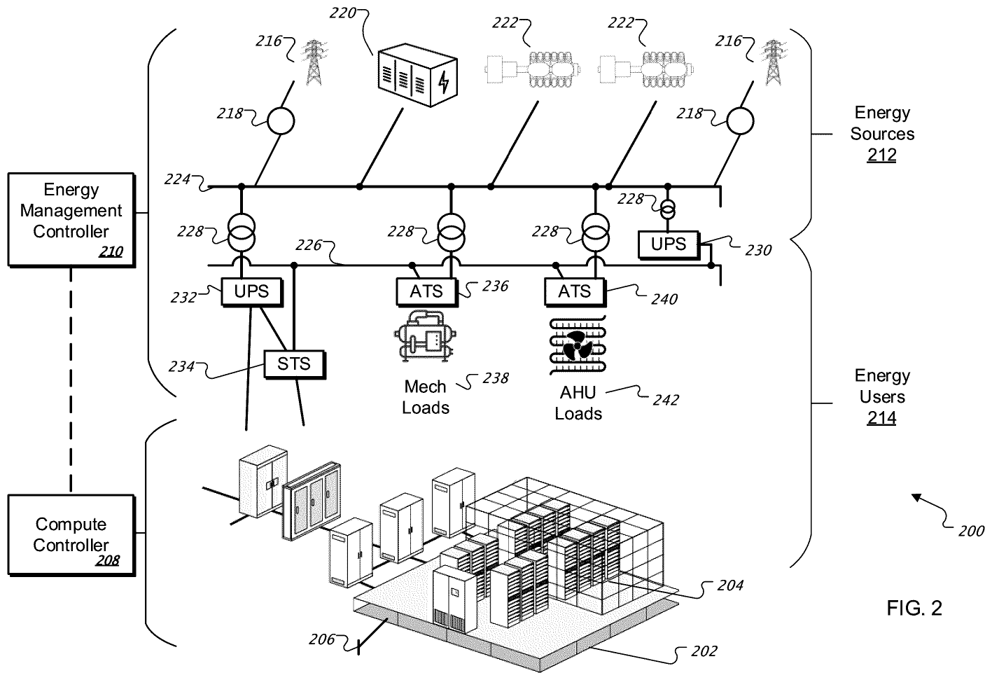

FIG. 2 is a block diagram of physical components and their interaction in a computer data center to provide power and cooling. As described above, these various components may interact to identify a future need for electrical power (including by determining a future need for cooling and other services) and to deploy the resources, as dispatchable assets, needed to meet that need, subject to certain defined goals, such as minimizing costs or carbon generation, or maximizing efficiency (e.g., running at a higher load level) or flexibility (e.g., running at a lower load level so as to leave room for future changes).

In the figure, a system 200 is shown centered around a data center 202 facility. The data center 202 may take a variety of forms and is shown in simplified form here with its walls and roof removed, and with a number of rows of computer racks 204 inside. Each of the racks 204 may contain a number of computer servers, power supplies, networking components, and the like, needed to serve a variety of demands, such as e-commerce processing, artificial intelligence (AI) processing, generation of search results, operation of back-office operations for a business (or multiple businesses in a multi-tenant data center model), and a variety of other uses. The data center 202 may be dedicated to a single tenant or may be shared among multiple tenants, either by physically demarcating machines or physical zones for certain tenants, or sharing machines among multiple tenants (e.g., using virtual machine technologies).

A data connection 206 connects the data center 202 to the internet and other relevant networks. The connection 206 can take a variety of forms, and multiple connections of multiple different or similar types may be employed so as to provide adequate bandwidth, security, and redundancy for the data center 202. Requests for computing may arrive via the connection 206 (e.g., in-coming e-commerce orders, search queries, requests for service of web pages, etc.) and the data center 202 may process those requests in appropriate manners to generate responses that can be sent out via the connection 206 (e.g., serving of web pages and other data).

A compute controller 208 provides general management of the “compute” side of the data center 202, in terms of the processing the data center conducts as part of its main role. For example, compute controller 208 may track incoming requests over time and determine a typical compute load for the data center 202, and may communicate with other off-site systems to lessen the load or indicate that free capacity is available. As a result, compute controller 208 may cause computing jobs to be scheduled over a time period of seconds, minutes, and hours, such as by receiving a request for training of an AI model that is estimated to take 10% of the data center 202 capacity for four hours. The compute controller 208 may then schedule that job for a future time period or periods, such as by breaking it up and processing portions of it over-night, when historical data indicates that the data center 202 is otherwise under less of a compute load, and when utility prices may be relatively favorable. The compute controller 208 may be or may implement the functionality of a cluster scheduler.

In a multi-tenant situation, compute controller 208 may track usage by different tenants for purposes of billing and to ensure that each tenant is receiving its contracted-for capacity and not more or less. Compute controller 208 may also apply various rules, such as by allowing over-use by certain tenants upon appropriate notice, and in limited circumstances. Also, in a multi-tenant environment, compute controller 208 may total up the total expected compute as a sum of all expected compute loads that each tenant sends in, or to which each tenant is entitled, with some corrective factor based on historical experience, so as to predict future total compute loads for a facility, site, or global system.

In addition, compute controller 208 may build models of the compute usage by the data center 202 over time, and continuously update those models so as to better schedule future compute needs. For example, the models may show a general pattern of compute activity for each day of the week across 24 hours. Such models may then be used to determine that certain types of compute load (e.g., web search or e-commerce) are likely to rise or fall a certain amount over the next n minutes or hours, and a prediction of needed data center 202 utilization for that period may be determined. The actual data for that period may subsequently be used to update and tweak the model as part of a learning process, where the model is initially and/or continuously trained on new data about compute load. Such compute model may also be muti-factored, including by incorporating indications of different types of processing, changes in the mix of processing (e.g., if a tenant has left or entered the data center 202 mix, or if the tenant needs particular types of processing such as CPUs vs. GPUs), and similar factors, so that an overall compute load can be built up from sub-models for each of the different components that produce that overall compute load. In addition, compute controller 208 may, as indicated above, schedule certain types of non-critical jobs and communicate with systems run by tenants so that the tenant systems can notify compute controller about expected compute jobs, and the two may negotiate or otherwise communicate to determine how and when the data center 202 will handle those jobs, and how much they will cost the tenant(s).

In communication with the compute controller 208 is an energy management controller 210. As the compute controller 208 monitors, models, and controls data usage by the data center 202, the energy management controller 210 monitors, models, and controls electrical power usage that is associated with the data usage (along with related functionality like cooling). A dotted line shows that the two controllers 208, 210 communicate with each other to perform such functions. As one example, the compute controller 208 (which may in common circumstances be provided by a different organization than energy management controller 210, such that the two can communicate using an agreed-upon API) may periodically or nearly continuously send to the energy management controller 210 data that indicates a compute level that the data center 202 will be seeing in the near future (the coming seconds, minutes, or hours), and that energy management controller 210 can convert that compute load into an expected heat load for the components inside the data center, like the racks 204—where that heat load will need to be removed. The compute controller 208 may alternatively determine the heat load (which may be expressed as a profile over time, regardless of what component determines it) and send that to energy management controller 210.

Energy management controller 210 may make determinations about what components to dispatch, at what level to operate them, and when to operate them, based on one or more goals, which may include minimizing energy costs, minimizing carbon footprint, minimizing other environmental effects such as external noise generation overall or at certain times of the day, maximizing data center availability, and maximizing the life span of data center components. Minimizing cost may involve shifting operations to off-peak times when energy costs are lower (e.g., at night, for grid costs), such as by delaying compute jobs that can be delayed, using a BESS or genset to provide power during peak times, shifting compute load between data centers, or other techniques. Minimizing cost and carbon or other environmental effects may also involve operating the data center more efficiently, such as by operating components in a “sweet spot” of their power curve, which might be in the middle of their operating capacity. For example, if a data center has multiple chillers rated at 100 (a dimensionless number used here for clarity) and has a projected need of 200, it may operate three chillers at 67 each (more efficiently) rather than two at 200 each (less efficiently). The operation of components away from their maximum load can also extend their lifespan and increase their availability, and thus indirectly decrease costs also.

As described here, the energy management controller 210 may be programmed to take into account each of these concerns, weight them appropriately (e.g., by converting energy costs, repair/replacement costs, and downtime costs to a common value, and minimizing that value), and determine an optimal operating path for a data center 202. Each time a data center 202 makes such operating decisions, it may also gather data on its actual performance compared to its expected performance, and may provide that data to a machine learning system as training data for updating a model that is used for making the determinations—and such model(s) may be shared between and among data centers in different geographic locations. In this way, then, the system may continuously improve. The particular type of machine learning to be used, the data to be collected, and the manner in which the data is processed, may vary based on the particular application.

As part of such processing, energy management controller 210 monitors and controls a number of components or devices that are shown schematically here to a “North” side of the data center 202, though in actual implementation, they would be located where physical practicalities dictate, e.g., to lessen the need for complicated piping, to permit access to the components (e.g., perhaps with heavy equipment) and to other parts of the data center, and by other considerations. As shown in the example here, the components generally fall into two groups: energy sources 212 and energy users 214.

The energy sources 212 may generate electricity initially and/or may store and later provide electricity generated by another source. Shown here, there are two distinct grid sources 216, whereby a data center may negotiate to have electricity provided by two different utilities, so as to improve capacity, cost, and reliability. Each grid source 216 is shown connected to a medium voltage (MV) electrical bus 224 via a meter 218 by which electrical use by the data center 202 from the respective grid can be measured for, e.g., billing purposes. The meter 218 or an area near it may also define the relative responsibilities of the utility and the data center 202 operator for maintaining and repairing equipment in the system 200. The MV bus 224 may in turn be connected to a low voltage (LV) bus 226 via respective transformers 228. The buses 224, 226 may be fully or partially conceptually parallel to each other, and as needed, particular components may connect to the MV bus 224 rather than the LV bus 226 or vice-versa, depending on the implementation and component needs.

Another source is a group of large battery banks 220, e.g., equal to or greater than 1 MWH each, or total, and may take the form commonly known as a battery energy storage system (BESS), which includes the battery cells and associated management and control resources. The banks 220 may use a variety of chemistries and may be sized to operate the data center 202 for a certain minimum necessary time period at a typical load, such as 30-60 minutes or one hour or several hours or 24 hours. As described more fully below, the banks 220 may be used to provide power during limited time periods when power is not available from larger sources such as the grid, to provide additional power above that is available from other sources, to allow for smooth shutdown of the components in the data center 202 under certain emergency conditions, to load shift by charging the banks 220 during the night and discharging them during the day, and other similar uses.

The other energy sources are gensets 222, in the form of natural gas or other-powered engines powering generators, again connected to the MV bus 224. Other energy sources may also be provided, such as small-scale fusion, water circulating through geothermal loops, wind generators, piezoelectric solar, hydrogen-cell generation, and the like. While such sources will generally be operated by the operator of the data center 202 or by a separate utility, they may also be operated by a dedicated third party, such as a syndicate that develops power sources to be served mainly or solely to a small group of data centers under contract, such that the syndicate would not be a full-blown utility.

The energy users 214 include the various main components that require electrical power as part of the operation of data center 202. For example, a UPS (uninterruptible power supply) 232 and STS (static transfer switch) 234 may connect the LV bus 226 to the servers 204 and other electrical components that are part of the data processing for the data center 202. The STS 234 may normally carry power from the bus 226, while the UPS 232 charges from the bus 226, and when there is no power from the bus 226, the UPS 232 may automatically and quickly activate, and the STS 234 may simultaneously switch so that the compute infrastructure of the data center 202 is provided from the UPS 232. Such functionality may also be incorporated with a BESS so that, depending on the situation, the BESS may quickly switch upon indication of an interruption so as to provide uninterrupted supply, and in non-emergency situations can provide a scheduled switch so as to provide power that is desired (e.g., to permit load shifting) but not required in the manner UPS power would be.

Other energy users 214 include mechanical loads 238 which are connected to both buses via an ATS (automatic transfer switch) 236. The mechanical loads 238 may include, for example, chillers, cooling towers, and related pumps. Further down the cooling system are AHU loads 242 also connected by an ATS 240. The AHU loads may include fans and other pumps that circulate warmed air and cooling water through coils to effect heat transfer out of the data center 202. The cooling water may circulate into the data center 202 building to the AHU loads 242, may gain heat there, and may then circulate outside the main building and through chillers or cooling towers as part of the mech loads 238.

Finally, a separate transformer 228 and UPS 230 are provided to power the LV bus 236. As noted, such functionality may be stand-alone as shown, or may be integrated with other functions related to delivery of stored electrical energy, such that the BESS may be used in certain implementations to provide such back-up power. The transformer 228 and UPS 230 here may pick up loads otherwise served by other branches should their connections (e.g., their respective transfer switches) fail or otherwise lose primary power.

In operation, energy management controller 210 may take in information from a variety of sources to determine how much cooling will be needed for data center 202 in the near future, and then how much electrical power will be required to achieve that cooling (and also the electric power needed to perform the compute operations that create the heat that requires the cooling). The sources include, for example, information that allows the level of compute to be converted to an expected level of heat generation (which may come from learning models), current and future ambient temperature and humidity for the area around the data center 202 for the relevant time period, information about the efficiency and operability of particular energy sources 212 and energy users 214, and models that relate such other variables to relevant needs for electric power. The information about the operability of particular energy sources may include information about whether certain devices are currently on-line or off-line, e.g., for maintenance or repair. For example, a chiller manufacturer may provide, in memory shipped with the chiller or at an on-line resource accessible over the internet, an indication of electrical power required to operate the chiller at different tonnage levels, and the system can access such information in determining how much electricity will be required to provide n tons of cooling for the time period under certain ambient air conditions. (As noted elsewhere, the system may also learn the operating parameters of a particular chiller over time, and may supplement or replace the manufacturer data with real, observed data.)

Energy management controller 210 may use such information to determine how much cooling and electrical power will be needed over a defined future time period, and may take actions to make such cooling and power available. For example, energy management controller 210 may provide information to a related computer operated by a utility 216 to indicate future needs for electrical power and/or may consult data about the rate agreement the data center 202 has with the utility 206, to determine whether to use power from the particular grid during the defined period (and how much power to use). Energy management controller 210 may check with one or more of the energy users 214 to confirm that such user is available for operation, and may consult data on each such device's capacity levels (e.g., in BTUH, and an associated electric usage at that design level).

Energy management controller 210 may also be programmed so as to make data center 202 an active grid participant. For example, energy management controller 210 may dynamically negotiate with one or more grids/utilities for electric pricing for upcoming periods (seconds, minutes, or hours), such that each grid can look at its current capacity and provide a lower bid (lower than a previously-negotiated agreement) if its current and near-future capacity is relatively high—and where the parties can agree to the delivery of a certain amount of electric power for a certain price. Energy management controller 210 can also send a utility 206 information about its anticipated future needs for electric power, so as to enable the utility 206 to better manage its system, such as by maintaining certain turbines and generators in operation if the data center 202 indicates that it will have a high power need in the near future.

Such information about needs and availability may run in both directions (from energy management controller 210 to utility 206, and vice-versa) and occur repeatedly, so that the two entities are constantly updating each other on needs and supplies. As one example, energy management controller 210 may have an indication that, by a rate agreement, the cost of power will fall in 60 minutes. But it may have a need to perform some level of compute sooner, and thus may send the utility 206 a request to obtain power at the reduced rate starting an hour early—a request that the utility 206 may satisfy if its systems tell it that it will likely have excess capacity over the next hour. Information flow and power flow may also be reversed, in that the utility 206 may request information about power that the data center 202 might be able to provide to the grid, such as by turning on certain gensets or depleting certain battery banks. The two may agree on an amount of power over a certain time period, and may control their respective systems to make power flow back onto the grid, and for data center 202 being credited monetarily or otherwise for the provision of the power.

Energy management controller 210 may perform “load shaping,” such as controlling when compute is to be performed (where some of the compute is not time-sensitive) or delaying the onset of cooling or other services. As such, energy management system 210 may prevent the load from exceeding a determined maximum, while maintaining the load near the maximum—i.e., to flatten the load overall. Such load shaping may also have discontinuities nears changes in pricing or other goals, such that load may be increased step-wise at night after rates fall, or may be decreased or otherwise altered at night (e.g., operate components away from a populated area) if ambient noise around a data center is a consideration. Such load shaping may also occur even if the data center operator does not own or otherwise control the load.

For example, an interface may be provided between energy management controller 210 for a data center 202 and systems operated by one or more tenants (e.g., in a cloud, multi-tenant operation) whose compute is handled by the data center 202. The interface may institute a dialogue by which energy management controller 210 offers lower compute pricing if the tenant allows a certain amount of their compute load to be delayed, or an auction with multiple tenants. Energy management controller 210 may initially inquire of the tenant about its flexibility—e.g., to indicate how much of its anticipated needs are not time-sensitive and how long they may be delayed. If such tenant information meets the load shaping needs of energy management controller 210, then energy management controller 210 may offer a certain discount and the tenant may respond by accepting or rejecting the discount. Such communication may occur automatically (and quickly) between the data center 202 and tenant systems, and may occur many times per hour or day.

Such load shaping for power purposes may also be provided as an adjunct to normal load shaping that the data center 202 may perform with its tenants, that is directed to making sure the compute capacity is not suddenly overwhelmed by near-simultaneous requests from multiple tenants. In this manner, energy management controller 210 may have successive communications with utilities and its tenants over a short period of time (seconds or minutes) to determine both the utilities' flexibilities and price-sensitivity to delivering power at certain times, and its tenants' flexibilities and price-sensitivities about having compute performed during certain times, so as to shape a compute curve and power curve cooperatively in a manner that minimizes or maximizes a desired goal, such as electrical spend as compared to compute revenue.

Energy management controller 210 can also communicate with one or more grids 216 about power that the data center 202 could provide to the grids (rather than take from the grids). For example, data center 202 may have control over a BESS, genset, or renewable energy source (e.g. wind or solar or geothermal), where the source has the ability to provide more power than the data center 202 will currently need—either for its expected near-future needs or if the data center 202 delays certain compute projects and thus lowers its own expected power needs. In such a situation, the data center 202 may communicate with one or more grids, indicating the timing and amount of power that it might be able to make available to them. The grid(s) may then each indicate whether they have a need for such power. Thus, for example, data center 202 may find that it has fewer compute jobs in the afternoon, when cooling loads for customers of a grid are at their maximum, and data center 202 may then “sell” power back to the grid 216, e.g., to offset what it would otherwise owe to the grid. Such a process may also be instituted by a grid 216, such as the grid 216 recognizing that it will have a defined “down time” for a portion of its generating structure due to planned maintenance, such that the grid may schedule a time and amount of power that it will receive from the data center 202, which may in turn charge its BESS to deliver such power at the relevant time, or prepare to power up one or more gensets to provide the power. These dialogues may be fully automatic (e.g., with the energy management controller 210 automatically determining its future needs and either consulting a rate schedule or performing an ad hoc auction or negotiation over rates) or partially automatic (e.g., with a person operating the energy management controller receiving a recommendation from the system, and then indicating whether a proposed transaction with the grid should occur). In this manner, the data center 202 operator may serve as a cooperative partner with the grid 216 operator even though they are two different corporate organizations with their own needs and interests. More broadly, data center 202 may periodically (e.g., every minute) send a notification to its utilities about whether it is undersubscribed, evenly subscribed, or oversubscribed (or could break the levels into n different levels of severity rather than the three just mentioned), and the utilities can thus be kept up-to-date on whether an inquiry from them to receive power from the data center would be likely to be positively or negatively received.

The system 200 shown here may also allow more modular deployment and management of data center 202 components. For example, particular energy users may be manufactured as plug-and-play modules that can be physically connected to system 200, with valves (or switches) then opened, and the added energy user 214 or source 212 may immediately provide cooling or other services. That module may then be disconnected and added at another site in a similar manner. Or piping stubs and electrical circuits and connections may be built initially with isolation valves/switches for n multiple taps along a piping or electric circuit. Data center 202 may initially become operational with only 1 of n devices in operation, and as computer servers are added inside the data center 202 building, modular devices can be added in coordination (and by matching capacity to the amount of compute load that currently exists in the facility), one-by-one (or otherwise in discrete steps) until all the taps are taken and the system is at full operation. Where previously-defined interfaces (e.g., for data connections, piping connections, and electrical connections) for connecting equipment is followed, needed on-site labor may also be substantially reduced.

The system 200 may also be readily operated at different levels of capacity based on decisions made by energy management controller 210. For example, certain system components may have high reliability and/or high efficiency when operated at 70% of capacity (or below), so that energy management controller 210 can seek to stay at or near 70% during most operation. However, if a compute load arrives that needs to be performed quickly, energy management controller 210 can determine how much of the compute load can be handled per minute while running the energy users 214 at perhaps 90% or 100% of capacity, and can achieve the processing with a short period of full-speed operation or over-subscription. Or if 100% operation is needed to meet the load, energy management controller 210 can operate the cooling components at 80-90% but run them for a longer time period, so that temperatures might rise slightly since the compute load exceeds the cooling load for a time period (perhaps several minutes), but then the cooling can exceed the heat load from the compute for a time, and bring the system 200 back into balance.

Similar considerations may come into play for the system to maintain steady operation during an afternoon period that is particularly warm. There, energy management controller 210 may determine from publicly-available forecast information that extreme heat will last 3 hours, and then the ambient temperature will drop because of an arriving cold front. Energy management controller 210 may thus cause the energy users 214 that perform cooling to operate at high levels for the three hours (and may draw down the charge on battery banks 220), knowing that the over-sized demand will be over in about three hours.

Energy management controller 210 may consider the various components that it controls as being fairly generic dispatchable assets. It may be programmed to understand, from a model, their effect on electrical supply available on the buses or their effect on cooling water available in a chilled water loop, without having to be concerned with further details of their internal operation. In such a situation, the controller, in determining which devices to send commands for operation, may look just to the device parameters that matter to its computations, and select particular devices and operational variables for those devices—and then send commands to achieve such ends in a basic dispatching model.

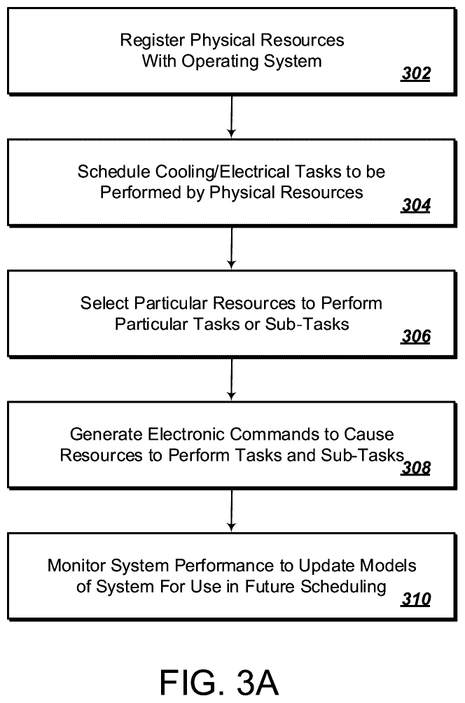

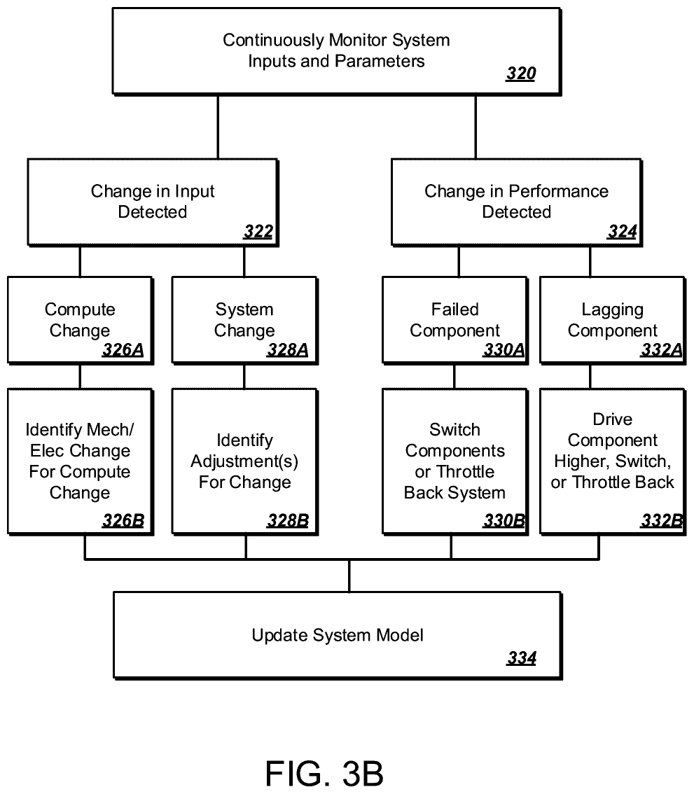

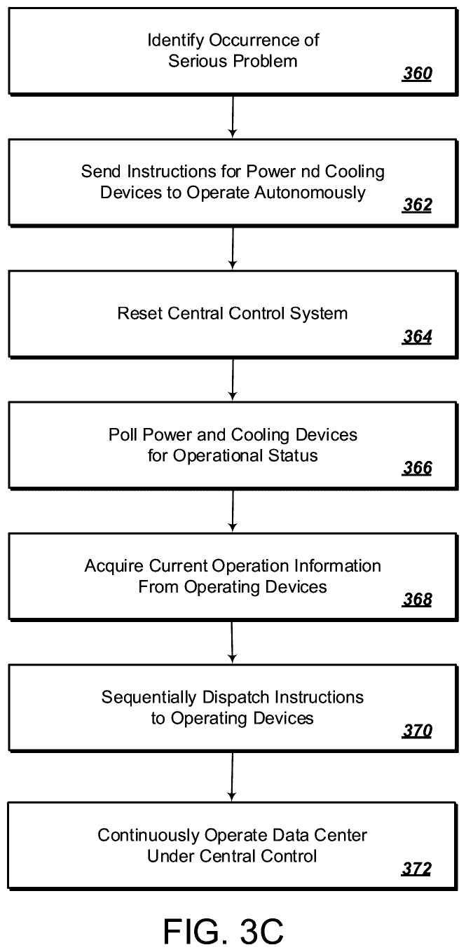

FIG. 3A is a flow chart showing enrollment of, and operation of, a physical component in a computer data center. In general, the process involves an operating system identifying devices for supporting compute functions in an operating system, determining availability of such devices initially and over time, and dispatching the devices to perform relevant services such as providing cooling that is matched to a current or recent level of heat load in the data center.

The process begins at box 302, where physical resources are registered with the operating system. Such registration may occur at a number of different times and a number of different manners. For example, an OS may poll its network for available devices (e.g., sensors, chillers, racks, pumps, fans, BESSes, gensets, valves, etc.) when instantiation of the OS first instituted, upon booting, periodically, or in response to an enrollment request from a newly-connected device. Also, devices may announce themselves when they are initially powered on and connected to a network. Such registration may occur without user intervention or with partial user intervention (e.g., the user is displayed a pop-up window and allowed to make limited configuration choices), such as by using plug-and-play techniques for device registration (e.g., UPnP). As part of the registration, the device can pass information about its capabilities (e.g., a chiller can send information about its capacities and efficiencies) to the OS, or can pass identifying information (e.g., a URL) that allows a component working with the OS to obtain such information through the internet. Appropriate security mechanisms may also be used to ensure that non-authorized devices are not allowed to register themselves with the OS. Such initial actions may be performed in full or in part, for example, by kernel 112, resource manager 122, and boot sequencer 114 of FIG. 1 operating in energy management controller 210 of FIG. 2.

At box 304, electrical and/or cooling tasks that are to be performed by the physical resources are scheduled. In this step, the process moves from configuration (which may continue even after initial set-up of a system, for new or updated devices) to operation. In particular, the OS may take part in monitoring system operation and changes within and around the system, so as to select and control (dispatch) devices that will allow for the execution of compute functions and the support of such functions both effectively (so that compute is performed with few errors or break-downs) and efficiently (e.g., for minimum cost in terms of inputs like electricity). Such scheduling may begin by determining electrical and cooling loads expected to occur in the near future (seconds, minutes, or hours) for the data center.

That determination may begin by determining a level of electrical operation for the computing machinery in the data center, which may be a predictable transformation of an amount of computation that is expected to be performed over a set time period, converted to electricity needed to perform the computation, to heat that is generated by such computation, and then to electricity needed to remove that generated heat (perhaps along with a fairly consistent, and likely minor compared to the other loads, baseline for operation of lighting and cooling in office areas of the data center). Various algorithms, model data, and learning data may be used to perform such determinations, and a timeline of near-future electrical needs may be determined. Such timeline may have predetermined maximums, and the process may cycle back to remove or reschedule non-time-sensitive compute jobs if a maximum electrical usage for a system is exceeded—i.e., the scheduling of compute and of electrical use may be subject to a cap, which may be a set number, or may be more flexible, such as allowing the cap to be exceeded for a certain period of time if a determined level of BESS battery storage is available to the data center.

At box 306, particular resources for performing those electrical and/or cooling tasks are selected. Such selection may depend initially on identifying which resources are available—i.e., that have been registered and are not currently inactive for repairs or maintenance. It may then involve determining both real-time (e.g., Watts or BTUHs) and total capacities of the available resources (e.g., watt-hour and total BTUs). For example, using dimensionless number for clarity, the determination at box 304 may have determined that there will be a peak demand of 1000 and a total demand over an hour of 10,000, of cooling and/or electrical power. The identification of resources may initially determine that a BESS can meet the peak demand, but only has 8,000 units available (before hitting a minimum desired charge level) and thus cannot meet total demand. The selection, then, may use a different electrical source such as a grid or genset, or may use the BESS in combination with another source that can provide the 2,000 units (while the BESS provides its 8,000). In a similar manner, perhaps a system has multiple chillers with a capacity of 450. To meet the peak, three such chillers may be selected, or two chillers may be selected upon determining that a slight rise in chilled water temperature around the time of the peak load will not substantially affect the system operation. Available models of system performance can be used in such selections to determine both the capacities of particular resources and also the reaction of the system in the proposed use of particular resources. In some implementations, the system may perform one or more simulations using models of resource performance in the system, such as by selecting certain resources and then simulating both the effect of the compute load on the system, and the response by the simulated resources. Such simulation may be more complex, such as by performing multiple Monte Carlo simulations, each of which use slightly different atmospheric weather conditions over the simulated time period (e.g., indexed by 0.1 degrees C and 0.1% RH) and/or other variations of inputs—so as to generate a confidence level for proposed plans of action, and selecting the optimized plan of action that exceeds a minimum confidence level.

In selecting resources, availability of failover capacity may also be considered. For example, a BESS or genset may typically be used as the two back-up electrical power sources in a system. In such a case, if the other back-up is not currently available, then the remaining one might not be selected by the system as a resource to fill a load, so that it can stay available as a back-up in case something happens with the primary selected source (e.g., a grid or local renewable resource like solar or wind).

The selection may also take into account additional factors, such as economic factors. For example, an agreed-upon rate table with a utility may be consulted so as to determine the cost of using the utility for electric power during the relevant time period. As such, it may make economic sense to use grid utility power at night, and other sources such as a BESS during the day. Also, the BESS may be recharged using (cheaper) grid power during the night. As another example, the current cost for fuel to refuel gen-sets may be consulted so as to determine the economic cost of using the gensets. Alternative or additional factors may also be used, such as carbon effect, such that a renewable resource is always used if it is available, or is used as long as its economic cost is not more than X greater than the economic cost of a non-renewable resource.

In certain instances, the attempt to select resources may cause the process to provide feedback further up the system. For example, if the process determines that resources will be strained (e.g., it will remove a back-up source from being the only back-up or will operate a system over a safe level of its capacity) or that costs will potentially be excessive (e.g., peak grid pricing), the process can indicate as much to a sub-system that has the ability to analyze whether the work can be rescheduled or moved. For example, a global version of a data center OS may operate among and coordinate a number of instances of the OS assigned to particular sites or data center facilities. Upon receiving such feedback from one of the sites, it can poll the other sites to determine their ability to take on all or part of the load, and the costs of them doing so. As a simple example, where the central OS controls data centers around the globe, it can make efforts to redeploy compute to areas where it is currently nighttime (and thus there is less “local” compute to be performed and also lower grid prices). The central controller may then provide feedback to the local controller(s), indicating where the load will be borne, and what part of it each of the local controllers is responsible for bearing.

At box 308, the process generates electronic commands to cause the selected resources to perform the scheduled tasks. For example, a data center OS like that shown in FIG. 1 may send commands to end devices or to intermediate controllers. The commands may be as simple as turning a device (e.g., a pump) on or off, or more complex such as indicating to a device that it should control itself to operate (a) according to certain parameters (e.g., maintain a certain output temperature or stay below a defined maximum current draw); and/or (b) during a certain time period. The level of control that the system takes versus the level that any particular device takes will depend on the goals of the system, the chore for each device, and the capabilities of each device.

At box 310, the process monitors system performance so as to update models of the system such that the models can be used in future operation of the system. The scheduling of tasks, selecting of resources, and generation of commands discussed above may be updated nearly continuously, upon the occurrence of an event (e.g., a change in outdoor temperature, change in weather forecast, or arrival of unexpected additional compute jobs) or at a defined periodicity (e.g., every 1, 5, 10, 15, 30, or 60 minutes). Various sensors throughout the system may measure factors such as temperatures (e.g., of water entering/exiting chillers, of air entering/exiting server racks, etc.), current demands of particular devices or zones in the system, and other measurable parameters.

The process may then associate such measurements that reflect actual operation of the system with the various inputs provided to the system, and may update a model of the system accordingly for future use. For example, such monitoring may indicate that a particular server configuration generates particular levels of heat under particular compute loads. Acquired temperature data and compute-level data at various time periods may thus be used to generate a model that correlates compute loads to heat generation (and the time delay until the heat is “felt”), and such data may be integrated across part or all of a data center so as to produce a more general model. Such model may be implemented as a machine-learning model and continuously updated as new data comes in, and may be used in the scheduling, selecting, and control of resources discussed above. Similarly, other models may be generated and updated for other devices or groups of devices in the data center, such as a model of a BESS's ability to deliver electric power, the ability of a bank of chillers to provide cooling and the related energy usage from that bank of chillers, and other relevant operational features in a system.

Regarding changes in performance being detected (box 324), such changes could be a complete failure of a component like a chiller (box 330A) or a lagging component (332A)—a component that is still operating but not operating at a level that is expected. For a failed component (box 330A), the process may switch to another version of that type of component that can take on the load, or if that is not available, may throttle back the system (box 330B) so that whatever components are operating are able to keep up. For a lagging component (box 322A), the system can try to drive the component higher (e.g., set a lower chilled water cooling temperature for a chiller) or throttle back the system such as by spreading out the time that it takes to perform a scheduled compute, and thus generate less heat in the near-term.

Finally, at box 334, a system model may be updated. Specifically, data recovered from the abnormal operation of the system and from reacting to that operation may be added as training data to a learning system. For example, for a lagging chiller, the model may be updated to lower the amount of cooling the chiller can provide under the particular operating conditions. In addition, a maintenance alert may be generated for a human operating from such monitoring, so that they perform relevant testing of the chiller to see if the lagging is expected or atypical, and requiring of a repair (e.g., adding refrigerant).

FIG. 3B is a flow chart showing management of cooling infrastructure in a computer data center. In general, the shown process involves a data center OS reacting to changes experienced by the data center, in terms of adjusting mechanical and electrical resources in response to a variety of inside and outside influences on the data center operations. Those changes may come in a variety of forms, and an OS or other part of the overall system may continually listen, perhaps on a dedicated communication channel, for devices or sub-systems reporting new information. The OS may then change how currently-operating components are operating, or may add or remove components from operating in the system, so as to offset or respond to recently-received changes in the system operation.

The process begins at box 320, where system inputs and other parameters are continuously monitored. In particular, a data center control system may be instrumented to collect relevant information on periodic, frequent schedules (e.g., every second or minute). Alternatively, or in addition, the system may receive alerts when anomalies occur, such as by a sensor reporting an out-of-range value (e.g., high temperature or low BESS charge) even if it was not the time for reporting the value normally. Any appropriate change may result in the steady state operation of the data center changing, and could require a corresponding change in how the data center is operated by a data center OS like that shown in FIGS. 1 and 2.

The sensed system changes can take multiple forms, which may affect how the OS is programmed to respond. At box 322, the detected change is a change in an input, while at box 324, the change is a change in detection of the system performance, apart from changes in inputs. The former may take a variety of forms, such as receiving a message that the level of compute in a data center will change in the near future (and thus, e.g., the electrical needs of the computers will increase, and the temperature will increase unless countering measures are taken), receiving an indication from a temperature sensor that outdoor temperatures have increased or receiving an indication that a temperature forecast has changed, identifying from an internal or external database that utility rates from a utility provider have changed or will change during a future time of interest for the control system, and other typical or atypical changes in the system inputs. The latter may also take a variety of forms, including identifying (e.g., via performance monitor 118 in FIG. 1) that a particular component in a system is not performing as predicted by a model that has been used to determine future mechanical and electrical needs for a data center, such as determining that a new computing platform is generating more heat per unit of computing that it was expected to, or determining that a chiller is providing fewer BTUs of cooling for each input Watt of electricity than it previously was.

As to the change of an input (box 322), such changes can be identified as compute changes (box 326A) or system changes (box 328A), and may be addressed differently depending on such identification. A compute change (box 326A) involves changes of actual or expected compute load on a system. For example, using dimensionless numbers for simplicity, a normal steady-state for a particular data center may be 100, with jobs that need to be performed immediately such as search queries or streaming video, jobs that can be delayed slightly and vary over time but by a small and generally predictable amount such as email and other asynchronous communications, and related overhead for such compute load. A monitor may identify that such activity has increased by almost 20, is fairly steady, and is trending upward—above what the model had predicted, but in a shape consistent with other daily activity for such load. Or a sub-system may submit a request for additional compute at a level of 20 that is expected take an hour to perform. In either case, this compute change will need to be addressed by the mechanical and electrical systems. Alternatively, a system change (box 328A) may be any sensed change that is not a compute change, and may include a change in ambient temperature that does not match an expected change over time that the system is currently operating under. Or it may be an indication that a BESS is low, or that a piece of cooling equipment has failed.

In response to identifying any such changes, the system may recompute and rebalance the mechanical and electrical systems to counter the changes, as shown at boxes 326B and 328B. For example, at Box 326B, the process determines a level of mechanical load (e.g., heat) that will be generated by the new compute load (which could be higher or lower than the load the system had previously assumed for the same time period), and also a level of electrical load from the compute load (to run the computers) and the new mechanical load (to run the other equipment). At Box 328B, the system identifies adjustments to be made to address the sensed change in the system, such as looking to a model that correlates, inter alia and in the case of a change in ambient temperature, ambient weather conditions and compute loads to heat loads generated in the data center. The system may then send commands to particular devices or sub-systems so as to implement those changes (e.g., via device interface 108 of FIG. 1). And although not shown, the process may loop back to the beginning to continue obtaining sensed measurements for the system operation, and then make future changes periodically and/or in response to particular notifications from the system.

Such conversions and computations as indicated by boxes 326B and 328B may initially be performed using manufacturer data for devices or testing on individual devices (e.g., putting a fully-equipped motherboard in an enclosed test environment, feeding it controlled compute loads, and measuring the heat it generates at particular loads), and then multiplying such individual computations by the number of devices expected to be deployed. Such a simplified approach or other initial approach may then be modified and enhanced over time by training a learning system with actual data measured over time from the data center or particular defined parts of the data center as measured.

In this manner, components of a data center OS may operate with registered resources, such as computing, cooling, and electrical providing devices. The data center OS may be automatically adaptable in that it may respond to changes relevant inputs in the data center, and readily determine changes in controlled devices that will be needed to keep the data center operating stably and directed to desired goals, such as minimizing electrical costs, total operating costs, or carbon generation.

FIG. 3C is a flow chart of a process for rebooting a data center when a fault occurs. The process generally provides an example of how a data center operating system may recover from a system fault while minimizing disruption to the data center's operation. In this manner, a data center operating system can recover gracefully from major or minor faults in the system. The process shown here may occur during the operation of the system, as shown in FIGS. 3A and 3B, and may occur with an OS like that shown in FIGS. 1 and 2.

The example process begins at box 360, where the occurrence of a serious problem is identified. Such serious problem may take a variety of forms. At a most minor level, commands could be sent to an end device or sub-system so as to correct the problem, or commands may be sent to cause the device or sub-system to reset itself (e.g., via warm or cold reboot). In this example, however, the problem is more systemic and not easily correctable. The system may be provided with rules or other metrics to determine when a problem of such severity has occurred, such as by identifying that certain communications by the system have not been effective. As another example, a problem may at first be assumed to be less severe, but may be changed to being considered severe when efforts to fix the problem (e.g., sending commands to a device or sub-system to reboot) are not effective in ameliorating the problem.

At box 362, the problem has been identified as being severe, such that instructions are sent to power and cooling devices to operate autonomously. For example, a fully-operating system may involve certain devices expecting to receive highly-defined commands at frequent periods (e.g., every minute). The instructions in this step may indicate to such devices that they should operate for a longer time (e.g., 30 minutes) at their current level, or should operate continuously at the current level until further notice. For example, a chiller may be told to maintain a particular chilled water output temperature until further notice, or fans at server racks may be told to operate at a particular speed until further notice. Such action may be accompanied by steps to limit the level of compute in the data center. For example, if the maximum compute that the electrical and mechanical systems can support is 100, the process may indicate to a system that schedules compute jobs that it should schedule for a maximum of 50, 70, or 80, for example—until the full system has recovered. The compute scheduling system may then delay certain non-time-sensitive compute jobs so as to maintain the lower operation level, while the data center OS reboots or otherwise resets. In this manner, the data center can remain operational at a sufficient level, and then return to an optimal level in the near future, when the outstanding problems have been cleared.

At box 364, the central control system is reset. Such a reset may be analogous to the warm or cold boot of a personal computer, and may involve clearing volatile data sources and reloading data from non-volatile sources, so as to clear out any potential data corruption problems that could be creating the problem the system faces. Also, rebooting may involve the OS initially checking various system components for proper operability, and may throw an error if problems are encountered, or switch to operable components (e.g., using different memory if the reboot indicate a memory error) and continue the re-booting process. During this time, the devices of step 362 may continue to run autonomously, in a form of “safe” mode for the data center.

At box 366, the OS polls power and cooling devices to identify their operational status. Thus, once the OS is up and running, it may reach outside itself to start to identify how it would like to reconstitute the electrical and mechanical systems. As such, the OS may poll all the components that it controls to obtain feedback about whether they are operational and how operational (e.g., what is their current safe and maximum capacity, and how much time do they have until required maintenance of other break-from-service events).

At box 368, the various devices or sub-systems respond to the OS to report their availabilities, capabilities, or both. Such responses may require the devices to poll themselves, such as by performing fresh self-checks to determine that they are operable. The devices that continued to operate during the down-time for the OS may also report to the OS their current operating parameters, such as remaining charge for a BESS, chiller water exit temperature for a chiller, computer rack entry and exits temperatures for rack-level fans, and the like.

At box 370, the OS sequentially dispatches instructions to the various devices, so as to update the operation of some devices, cease operation of others, and start operation of still others. Such instructions may be identified using mechanisms like those discussed above—e.g., determining a level of expected compute load for a future time period, determining levels of mechanical and electrical load from the compute load and other factors (e.g., cooling of auxiliary spaces, outdoor temperature and humidity, etc.), identifying which devices are available to meet that load, selecting the optimum devices and parameters for operation of those devices, and generating commands that will cause the devices to carry out the plan. The ordering of the transmission of commands and/or execution of the commands may also be controlled by the OS, such that various devices are brought up in a proper sequence, so as to prevent harmful spikes in demand and to ensure that, e.g., electrical supply is made available before mechanical demand is asserted.

At box 372, the system has hit full operational status and is operating at essentially a steady-state (as steady as is possible for a system whose inputs are constantly changing). In this mode, the relevant starting devices and other resources have been dispatched into operation and the data center is operated in a manner that generally balances mechanical operation with needs created by ongoing compute, and electrical supply with electrical demand. The system may periodically or in real-time consider changes in relevant inputs (e.g., a chiller failing, outdoor temperature changing, or an unexpected arrival of compute load), and dispatch already-operating or new resources to address such changes. For example, if the data center has finished processing a large scheduled job (e.g., overnight updating of a learning model for a machine-learning system), it may cause a sub-section of the data center to be made inactive for the time being, and may also shut down one or more chillers or other devices in a bank of such devices so as to better match cooling that is being provided to the data center to the expected cooling load created by a forecast compute load over a defined future time period. In addition, the system may preemptively detect device failures in a data center, such as by comparing current operations of devices or sub-systems to historical data and models of the device and sub-system operation, so as to identify when operation falls outside the norm, and thus may indicate an imminent failure. As one example, certain equipment may fall in a predictable manner in terms of efficiency when a particular component of the equipment is showing excess wear. Or a machine may have higher variability in its output when it is about to fail, and the system can provide an operator with a warning of the potential pending failure, and in appropriate circumstances, can power the device down and replace its operation with another parallel device in the system (or by increasing the load taken on by other already-operating devices).

In this manner, the process just described can respond to small, medium, and large interruptions in the operation of a data center. As examples, for a small interruption, a data center OS may determine that a device has or will go off-line (e.g., a BESS ran out of available power, a fan has failed, or a device has scheduled maintenance or downtime to avoid a too-high utilization rate), and the OS may cause a separate such device to be activated and take over. For a medium-level interruption, one or more sub-systems can be reset or otherwise cleared of whatever is causing them to be inoperative, with the data center OS controlling the parameters and timing of such resetting. And for a high-level interruption where multiple portions of the system are having operational problems and/or the central data center OS is having problems, a complete reboot or re-set may be performed as just described. In these manners, the reliability and robustness of a control system for a data center can be maintained, and the data center can be operated at optimal capacity even when inevitable problems occur.

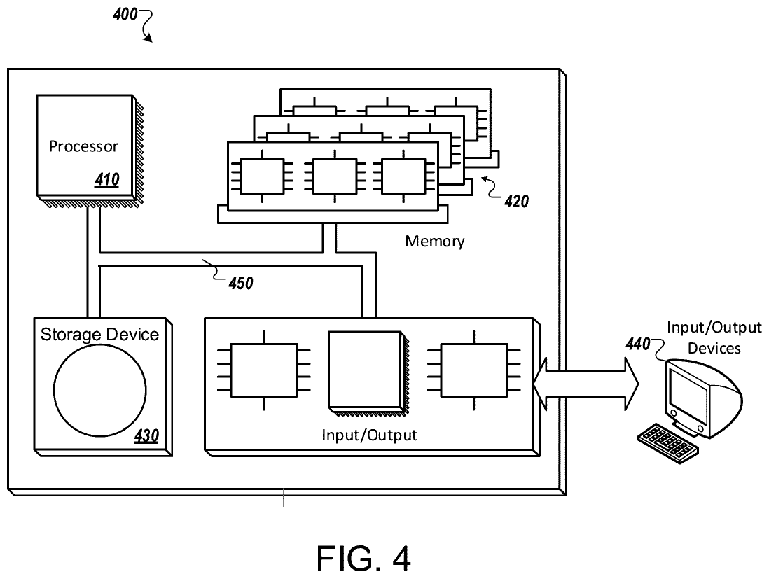

FIG. 4 is a schematic diagram of a computer system 400. The system 400 can be used to carry out the operations described in association with any of the computer-implemented methods described previously, according to one implementation. The system 400 is intended to include various forms of digital computers, such as laptops, desktops, workstations, personal digital assistants, servers, blade servers, mainframes, and other appropriate computers. The system 400 can also include mobile devices, such as personal digital assistants, cellular telephones, smartphones, and other similar computing devices. Additionally the system can include portable storage media, such as Universal Serial Bus (USB) flash drives. For example, the USB flash drives may store operating systems and other applications. The USB flash drives can include input/output components, such as a wireless transmitter or USB connector that may be inserted into a USB port of another computing device.

The system 400 includes a processor 410 (e.g., CPU or GPU and related components), a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, an SSD, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device.

A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks, SSDs, and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for managing physical sub-systems in a
computer data center using a data center-based operating system, the method comprising:
registering, with the operating system, a plurality of physical resources that serve the computer data center with electrical or cooling services;
scheduling, with the operating system, tasks that include electrical tasks, cooling tasks, or both, to be performed in response to compute loads to be encountered by the computer data center; and
executing, with the operating system, the scheduled tasks with one or more registered physical resources by selecting a mix of electrical power sources sufficient to execute the scheduled tasks and to optimize power use parameters defined for the computer data center.

2. The computer-implemented method of claim 1, wherein the plurality of physical resources comprise a source of electrical power connectable so as to power cooling components and computer server equipment.

3. The computer-implemented method of claim 1, wherein scheduling the tasks comprises determining a future amount of needed cooling or electric power based on a received indicator of computing to be performed by the computer data center, data indicating a change in a parameter that affects cooling or electric power for the data center, or both.

4. The computer-implemented method of claim 1, wherein the plurality of physical resources comprises distributed energy resources (DERs), and scheduling the tasks comprises virtually partitioning DER capacity for different uses in the computer data center.

5. The computer-implemented method of claim 1, further comprising updating a learning model of registered physical resources using data about recent performance by the registered physical resources, wherein the updating stores data indicative of how particular registered physical resources perform and parameters in which the registered physical resources performed.

6. The computer-implemented method of claim 1, further comprising monitoring background processes of the computer operating system to monitor and test operability of registered physical resources in the system.

7. The computer-implemented method of claim 1, further comprising automatically deactivating a registered physical resource upon determining that preventative maintenance is due for the registered physical resource.

8. The computer-implemented method of claim 1, further comprising determining with the operating system a timing of the scheduled tasks and selection of registered physical resources that will optimize a defined goal for the data center system, and causing the optimizing timing and selection of registered resources to be executed.

9. The computer-implemented method of claim 1, further comprising imposing secure communications between the operating system that the plurality of physical resources by requiring authentication and authorization before communicating data to particular ones of the plurality of physical resources.

10. The computer-implemented method of claim 1, further comprising:
identifying that a major fault has occurred in control of the plurality of physical resources;
in response to the identifying, causing the computer data center to operate at a reduced level safe mode while the operating system corrects the major fault;
resetting operating system; and
re-imposing control over the ones of the plurality of physical resources by the operating system.

11. The computer-implemented method of claim 1, further comprising:
during a boot of the data centered-based operating system;
polling previously-registered ones of the plurality of physical resources;
identifying current operating status of the plurality of physical resources; and
managing operation of the data center using at least a subset of the plurality of physical resources that is determined to be currently operational.

12. A computer operating system for automated management of a computer data center, comprising:
one or more resource drivers that allow the system to interact with physical resources that become registered with the system and that provide electrical or cooling services to the computer data center;
a task scheduler arranged to schedule tasks that include electrical tasks, cooling tasks, or both, to be performed in response to compute loads determined to be encountered by the computer data center; and
a device interface arranged to cause execution of the scheduled tasks with one or more registered physical resources by selecting a mix of electrical power sources sufficient to execute the scheduled tasks and to optimize power use parameters defined for the computer data center.

13. The computer operating system of claim 12, wherein the plurality of physical resources comprise a source of electrical power connectable so as to power cooling components and computer server equipment.

14. The computer operating system of claim 12, wherein scheduling the tasks comprises determining a future amount of needed cooling or electric power based on a received indicator of computing to be performed by the computer data center, data indicating a change in a parameter that affects cooling or electric power for the data center, or both.

15. The computer operating system of claim 12, wherein the plurality of physical resources comprises distributed energy resources (DERs), and scheduling the tasks comprises virtually partitioning DER capacity for different uses in the computer data center.

16. The computer operating system of claim 12, wherein the operating system is programmed to update a learning model of registered physical resources using data about recent performance by the registered physical resources, wherein the updating stores data indicative of how particular registered physical resources perform and parameters in which the registered physical resources performed.

17. The computer operating system of claim 12, wherein the operating system is programmed to monitor background processes of the computer operating system to monitor and test operability of registered physical resources in the system.

18. The computer operating system of claim 12, wherein the system is programmed to automatically deactivate a registered physical resource upon determining that preventative maintenance is due for the registered physical resource.

19. The computer operating system of claim 12, wherein the operating system is programmed to:
determine a timing of the scheduled tasks and selection of registered physical resources that will optimize a defined goal for the data center system, and
cause the optimizing timing and selection of registered resources to be executed.

20. The computer operating system of claim 12, wherein the operating system is programmed to perform the actions of:
identifying that a major fault has occurred in control of the plurality of physical resources;
in response to the identifying, causing the computer data center to operate at a reduced level safe mode while the operating system corrects the major fault;
resetting operating system; and
re-imposing control over the ones of the plurality of physical resources by the operating system.
